(19) United States
(12) Patent Application Publication
(10) Pub. No.: US 2025/0026349 A1
(43) Pub. Date: Jan. 23, 2025

(54) Rolling vehicle such as a mowing vehicle

(71) Applicant: Yuyao Actuator Electric Motor Co., Ltd, Yuyao City (CN)

(72) Inventor: Liu YANNIAN, Yuyao City (CN)

(21) Appl. No.: 18/684,065

(22) PCT Filed: Jul. 25, 2022
(86) PCT No.: PCT/CN2022/107653

§ 371 Date: Feb. 15, 2024

(30) Foreign Application Priority Data
Aug. 16, 2021 (CN) 202110936088.8

(51) Int. Cl. B60W 30/18; B60W 10/08

(52) U.S. Cl. CPC B60W 30/18036; B60W 10/08; B60W 2300/156; B60W 2420/20

(57) ABSTRACT

A rolling vehicle (1) has a chassis (2) equipped with a pair of drive wheels (3) and a system (4) for controlling the rotational driving of the drive wheels having two motors (5) and a control device (6) for each motor (5).

Each control device (6) has a second sensor (9) for detecting the angular position of said associated lever (7) about the first pivot axis (XX′), a memory (10) for storing the neutral position (PN) of said the lever (7) and a control unit (11) configured to, in the active state of the lever (7), control the speed and the direction of rotation of the associated motor (5) as a function of the data from the second sensor (9) and of the stored neutral position (PN). The control unit (11) is, in calibration operating mode, configured to order a storage of the neutral position (PN) corresponding to a datum supplied by the second sensor (9) at least as a function of the data supplied by the first sensor (8).

The present invention relates to a rolling vehicle such as a mowing vehicle.

It relates in particular to a rolling vehicle comprising a chassis equipped with at least one pair of drive wheels and a system for controlling the rotational driving of the drive wheels of the or of at least one pair of drive wheels, said control system comprising at least two motors and a control device for each motor, said motors being able to allow, for one, the rotational driving of one of the drive wheels, and for the other, the rotational driving of the other of the drive wheels of the pair of drive wheels, each control device comprising a lever controlling the direction of rotation and the speed of rotation of the motor associated with said control device and a first sensor, said lever, mounted to be able to be displaced within a first range of displacement in a way guided in displacement over a part of this first range of displacement being, in said first range of displacement, mounted to be movable by pivoting about a first pivot axis for the switching of said lever from an inactive state to an active state, this lever being, in the active state, mounted from a so-called neutral position to be movable by pivoting about a second pivot axis in a first direction, called forward, for a forward driving control at a variable speed of the associated motor and in a second direction, called reverse, opposite the first direction, for a reverse drive control at a variable speed of the associated motor, the first sensor being a sensor for detecting at least one position or range of positions of the associated lever within the first range of displacement, this position or range of positions forming a position zone of the lever in which any displacement by pivoting about the second pivot axis of the lever, which is guided in displacement, is prevented.

The rolling vehicles, such as utility vehicles, in particular mowing vehicles, with zero turn radius, also called ZT (zero turn) vehicles are known as illustrated in the U.S. Pat. No. 6,729,115. The present of two motors and the production of an output shaft in at least two sections make it possible to have a vehicle with two drive wheels which can be driven in rotation at different speeds and in different directions. The direction of the vehicle can thus be applied by simply changing the speed of rotation of the wheels. In practice, such a vehicle is generally equipped with two control levers, each of which controls a motor. When the two levers are pushed forwards simultaneously and with the same force, the vehicle moves forward in a straight line. When the two levers are pushed back simultaneously and with the same force, the vehicle moves in reverse in a straight line, and when one lever is pushed more than the other, the vehicle makes a turn. Pushing one of the levers forward and the other backward makes it possible to make the vehicle turn on itself. When the transmission of the movements of the levers to the motors is a mechanical transmission as illustrated in the U.S. Pat. No. 6,729,115, the vehicle is of complex construction. In recent years, vehicles incorporating control electronics have been developed. The difficulty is, in this case, how to accurately determine the position of the lever corresponding to the neutral position of the lever, this neutral position serving as reference position in the manipulation of the lever for controlling the direction of movement and the speed of the drive wheels. To make it possible to determine this neutral position, an individual programming of each vehicle is carried out in the factory. In practice, the operator in the factory positions the lever in the neutral position and orders this position to be stored using a button situated near the control unit. It is understood that such a procedure is time-consuming. Furthermore, such a procedure must be repeated in the event of a change or failure of a part of the control electronics. Furthermore, drifts in time linked for example to the wear of the mechanics cannot be taken into account.

One aim of the invention is to propose a vehicle of the abovementioned type whose design makes it possible to dispense, throughout the life of the vehicle, with a specific procedure for calibrating the neutral position of the lever that has to be performed by a qualified operator.

Another aim of the invention is to propose a vehicle of the abovementioned type whose design makes it possible to calibrate in real time and at the desired frequency, the neutral position of the lever, and in a way that is concealed from the operator.

To this end, the subject of the invention is a rolling vehicle comprising a chassis equipped with at least one pair of drive wheels and a system for controlling the rotational driving of the drive wheels of the or of at least one of the pairs of drive wheels, said control system comprising at least two motors and a control device for each motor, said motors being able to allow, for one, the rotational driving of one of the drive wheels, and for the other, the rotational driving of the other of the drive wheels of the pair of drive wheels, each control device comprising a lever controlling the direction of rotation and the speed of rotation of the motor associated with said control device and a first sensor, said lever being a pivoting lever with an active state and an inactive state, said lever being, in the so-called active state, mounted, from a so-called neutral position, to be movable by pivoting about a first pivot axis in a first, so-called forward direction, for a forward drive control at a variable speed of the associated motor, and in a second, so-called reverse direction, opposite the first direction, for a reverse drive control at a variable speed of the associated motor, this lever being, in the active state and in neutral position, mounted also to be movable by pivoting about a second pivot axis within a range of displacement, in a way that is guided in displacement over a part of this range of displacement, for the switching of said lever from an active state to an inactive state in which any pivoting displacement of the lever about the first pivot axis is prevented, the first sensor being a sensor for detecting at least one position or range of positions of the associated lever within this range of displacement, this position or range of positions forming a position zone of the lever in which any pivoting displacement about the first pivot axis of the lever, which is guided in displacement, is prevented, characterized in that each control device comprises a second sensor for detecting the angular position of said associated lever about said first pivot axis, a memory for storing the neutral position of said lever and a control unit configured to acquire the data from said second sensor and to, in the active state of the lever, control the speed and the direction of rotation of the associated motor as a function of the data from the second sensor and of the stored neutral position, and in that the vehicle comprises at least one so-called calibration mode of operation, in which the control unit is configured to order a storage of the neutral position corresponding to a datum supplied by the second sensor at least as a function of the data supplied by the first sensor. The neutral position corresponds to the angular position of the lever, taken with respect to the first pivot axis, in which the speed of rotation of the associated motor is zero, this position of the lever corresponding to the position of reversal of the direction of rotation of the motor. The idea of using the data supplied by the first sensor already present on the vehicle for other purposes to order a storage of the neutral position, that is to say the storage in the storage memory of the neutral position from a datum corresponding to a datum supplied by a second sensor makes it possible to perform this storage operation unbeknownst to the driver of the vehicle. Thus, the storage of the neutral position is performed as a function of the data supplied by the first sensor which detects the position of the lever in a position zone where the lever is prevented from pivoting about the first pivot axis. Thus, the neutral position is determined accurately without risk of a pivoting of the lever about the first pivot axis interfering with this determination. The first sensor is a sensor already present on such vehicles and is generally used as lever position sensor to detect that the parking brake, also called handbrake, of the vehicle is applied. In practice, the starting of such a vehicle is authorized only if the handbrake of the vehicle is applied. The data supplied by this first sensor which allow the control unit to determine that the lever is in the position zone detected by the first sensor or that the lever is displaced in the direction of an entry into or of an exit from the position zone detected by the first sensor have hitherto never been used to order a storage of the neutral position of the lever. There is therefore a simplification of the procedure for calibrating the neutral position of the lever and the absence of the need for a pairing in the factory of the neutral position within a predetermined mechanical position of the lever.

According to one embodiment of the invention, the control unit is configured to, in the so-called calibration mode of operation, order a storage of the neutral position corresponding to a datum supplied by the second sensor when the lever is in the position zone detected by the first sensor. In this embodiment, when the vehicle is started up, the lever is in the position zone detected by the first sensor. It is therefore sufficient, for the control unit, to save the datum supplied by the second sensor, this datum being a value of the angular position of the lever which is considered to correspond to the neutral position of the lever. The driver of the vehicle is in no way aware of this storage which is done automatically and unbeknownst to the operator.

According to one embodiment of the invention, the control unit is configured to, in the so-called calibration mode of operation, order a storage of the neutral position corresponding to a datum supplied by the second sensor when the lever is displaced in the direction of an exit from and/or of an entry into the position zone detected by the first sensor. In this embodiment, when the vehicle is started up, the lever is in the position zone detected by the first sensor. To provoke a movement of the vehicle, the driver of the vehicle displaces the lever from the inactive state to the active state. During this displacement, the lever exits from the position zone detected by the first sensor. This exit which corresponds for example to a change of state of the first sensor, can be identified by the control unit which acquires the data from the first sensor. It is therefore sufficient for the control unit, upon the detection of this change of state of the first sensor, to save the datum supplied by the second sensor. This datum is a value of the angular position of the lever which is considered to correspond to the neutral position of the lever. Once again, the driver of the vehicle is unaware of this storage which is done automatically and unbeknownst to the operator. The result of the above is that the control unit is configured, in the so-called calibration mode of operation, to order a storage of the neutral position corresponding to a datum supplied by the second sensor when the lever is in the position zone detected by the first sensor and/or when the lever is displaced in the direction of an entry into or of an exit from the position zone detected by the first sensor.

According to one embodiment of the invention, the control unit which is configured to, in the so-called calibration mode of operation, order a storage of the neutral position corresponding to a datum supplied by the second sensor at least as a function of the data supplied by the first sensor, is configured to order said storage if the datum supplied by the second sensor corresponds to an angular position value of the lever that is different from the value of the neutral position previously stored. Thus, the control unit orders an updating of the memory storing the neutral position only when the angular position datum of the lever with respect to the first pivot axis supplied by the second sensor corresponds to an angular position value of the lever that is different from the value of the neutral position previously stored, that is to say stored in memory storing the neutral position. As a variant, the control unit can order a storage of the neutral position corresponding to a datum supplied by the second sensor at least as a function of the data supplied by the first sensor independently of the value of the neutral position previously stored. Thus, the control unit can order a storage of the neutral position corresponding to a datum supplied by the second sensor at least as a function of the data supplied by the first sensor both when the angular position datum of the lever with respect to the second pivot axis supplied by the second sensor corresponds to an angular position value of the lever that is different from or identical to the value of the neutral position previously stored.

According to one embodiment of the invention, the so-called calibration mode of operation is an activatable/deactivatable mode.

According to one embodiment of the invention, the control unit is configured to, following a start-up of the vehicle and in the activated state of the calibration mode of operation:
detect, as a function of the data supplied by the first sensor, the position of the lever with respect to the position zone,
store, when the lever is in the position zone or is displaced in the direction of an exit from and/or of an entry into the position zone, the neutral position corresponding to a datum supplied by the second sensor at least if the datum supplied by the second sensor corresponds to a value of the angular position of the lever that is different from the stored neutral position,
deactivate said calibration mode of operation.

Thus, the calibration mode of operation can be activated by default when the vehicle is started up or be activated automatically at the moment when the vehicle is started up before being deactivated as a function of the data supplied by the first sensor. Provision can be made to reactivate this calibration mode of operation at a predetermined frequency during an operating cycle of the vehicle corresponding to the period between the starting and the stopping of the vehicle.

According to one embodiment of the invention, the lever being, in the active state, mounted from a neutral position that is movable by pivoting about the first pivot axis in a first, so-called forward direction, to a forward end-of-travel position for a forward drive control at a variable speed of the associated motor that is a function of the angular position of the lever with respect to the neutral position and in a second, so-called reverse direction, opposite the first direction, to a reverse end-of-travel position for a reverse drive control at a variable speed of the associated motor that is a function of the angular position of the lever with respect to the neutral position, the vehicle comprises at least one memory for storing the forward end-of-travel position of the lever and a memory for storing the reverse end-of-travel position of the lever and the control unit is configured to, as a function of the neutral position and of the stored forward and reverse end-of-travel positions, establish a curve of the speed. This configuration of the control unit makes it possible to adapt the curve of speed of rotation of the motor as a function of the angular position of the lever on each modification of the stored neutral position to maintain a progressive acceleration independently of the value of the angular position of the stored neutral position.

According to one embodiment of the invention, the neutral position, which is arranged on the path followed by the lever, in the state driven in displacement by pivoting of said lever about the second pivot axis for the switch from the active state to the inactive state, corresponds to the end-of-travel position of the lever in the state driven in displacement of the lever by pivoting about the second pivot axis for the switch from the inactive state to the active state.

According to one embodiment of the invention, each control device comprises a partial protection casing of the associated lever in which there are formed two guiding paths for the lever, these guiding paths forming between them a T with one of the branches, called first branch of the T, forming the guiding path of the lever corresponding to the part of the range of displacement of the lever where the lever is guided in displacement in the driven state of the lever about the second pivot axis and the other branch of the T forming the guiding path of the lever in the driven state of the lever about the first pivot axis, said guiding paths being configured such that any pivoting displacement of the lever about the first pivot axis is prevented in the state of the lever positioned in the guiding path formed by the first branch of the T, said lever being, in the inactive state, arranged in this first guiding path.

According to one embodiment of the invention, the chassis comprises a front end and a rear end and a longitudinal axis extending from the front end to the rear end, the first pivot axis of the lever of each control device extends transversely to the longitudinal axis of the chassis and the second pivot axis of the lever of each control device extends parallel to the longitudinal axis of the chassis. The expression “substantially mutually orthogonal” is understood to mean that the first and second pivot axes of the lever of the control device are mutually orthogonal to within plus or minus 20°.

According to one embodiment of the invention, for each control device, the first and second pivot axes of the lever of the control device are substantially mutually orthogonal. The expression “substantially parallel to one another” is understood to mean that the first and second pivot axes of the lever of one of the control devices are respectively parallel to the first and second pivot axes of the lever of the other of the control devices to within plus or minus 20°.

According to one embodiment of the invention, the first and second pivot axes of the lever of one of the control devices are respectively substantially parallel to the first and second pivot axes of the lever of the other of the control devices. “Substantially parallel” is understood to mean parallel within ±20°.

According to one embodiment of the invention, for at least one of the control devices, the first sensor is a proximity sensor with which the lever is, in the inactive state, in bearing contact at the end-of-travel position within the range of displacement and the second sensor is a potentiometer.

Another subject of the invention is a method for controlling the direction of movement and the speed of the drive wheels of a rolling vehicle, characterized in that, the vehicle being of the abovementioned type, the method comprises, in the so-called calibration mode of operation, a step of ordering, by the control unit, of a storage of the neutral position corresponding to a datum supplied by the second sensor when the lever is in the position zone detected by the first sensor or when the lever is displaced in the direction of an entry into or of an exit from the position zone detected by the first sensor.

### BRIEF DESCRIPTION OF THE DRAWINGS

The invention will be well understood on reading the following description of exemplary embodiments, with reference to the attached drawings in which:

FIG. 1 represents a perspective view of a rolling vehicle according to the invention,

FIG. 2 represents a perspective view of a rolling vehicle according to the invention taken from the rear of said vehicle,

FIG. 3 represents a functional schematic view of the control system of the wheels of a vehicle according to the invention,

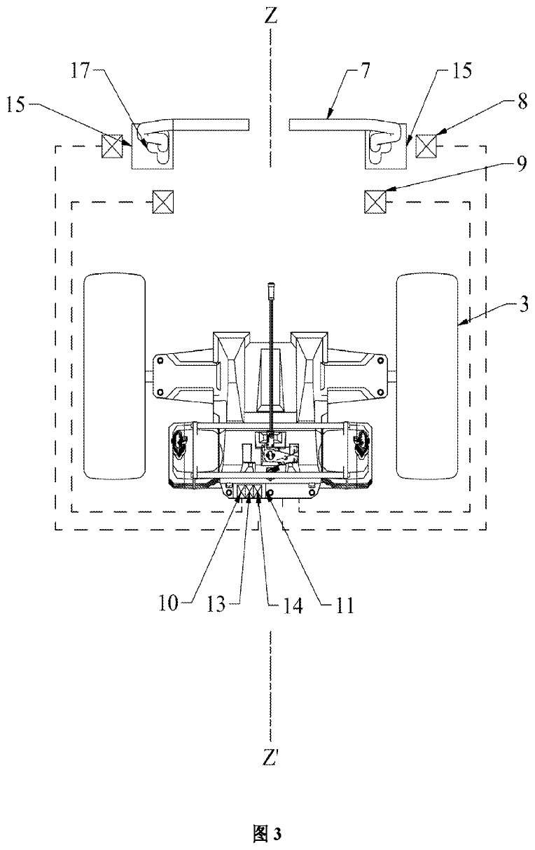

FIG. 4 represents, in the form of perspective views associated with cross-sectional views, different positions that can be taken by a lever of a vehicle according to the invention,

FIG. 5 represents schematic views in cross-section illustrating, for one, the positions of the levers in the active state, and for the other, the positions of the levers in the inactive state,

FIG. 6 represents, in flow diagram form, an example of method for controlling the vehicle with a view to a possible storage of the neutral position of a lever of the vehicle,

FIG. 7 represents, in flow diagram form, an example of method for controlling the vehicle with a view to a possible storage of the neutral position of a lever of the vehicle,

FIG. 8 represents, in flow diagram form, an example of method for controlling the vehicle with a view to a possible storage of the neutral position of a lever of the vehicle,

FIG. 9 represents a curve illustrating, on the y axis, the speed of rotation of the motor as a function, on the x axis, of the angular position of the lever.

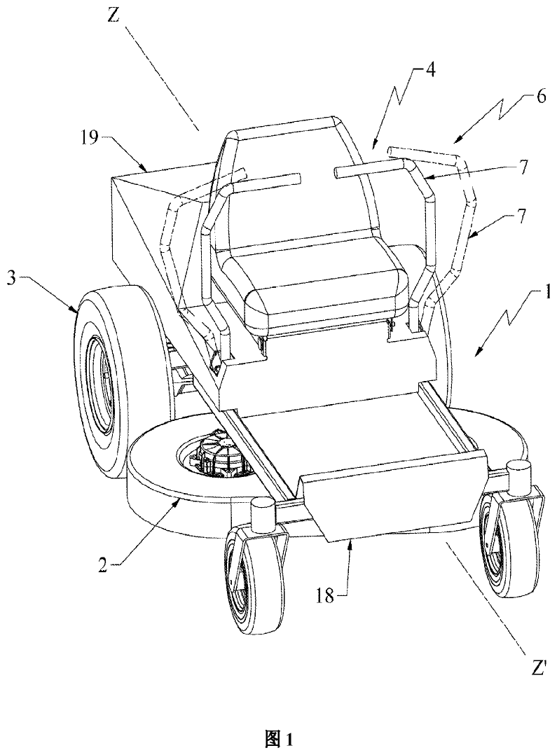

As mentioned above, the subject of the invention is a rolling vehicle 1 of the type of that represented in FIG. 1. This rolling vehicle is, here, a mowing vehicle which can be equipped with one or more rotary cutting blades for grass mowing.

This rolling vehicle 1 comprises a chassis 2 borne by four wheels bearing on the ground, namely two front right and left wheels and two rear right and left wheels. At least two of the wheels, namely at least the front wheels or the rear wheels, are drive wheels 3. In the example represented, it is the rear wheels which are the drive wheels 3 of the rolling vehicle 1.

The invention applies likewise to a rolling vehicle equipped with two front drive wheels.

The rolling vehicle 1 also comprises a system 4 for controlling the rotational driving of the drive wheels 3. This control system 4 comprises at least two motors 5 which, in the examples represented, are electric motors 5 with two directions of rotation. The motors 5 could, similarly, have been hydraulic motors as illustrated in the U.S. Pat. No. 6,729,115 without departing from the scope of the invention.

Independently of their design, these motors 5 operate independently of one another. These motors 5 can therefore allow, for one, the rotational driving of one of the drive wheels 3, and for the other, the rotational driving of the other of the drive wheels 3 of the pair of drive wheels.

In the example represented, each drive wheel 3 is linked to a shaft section of an output shaft formed in two coaxial shaft sections mounted to rotate freely with respect to one another. The two shaft sections are, for example, linked to one another by a sleeve to allow such a rotational independence. Each electric motor is linked by a transmission to at least one of the associated shaft sections to allow it to be driven in rotation in one direction or in the other and, consequently the associated wheel to be driven in rotation. This transmission will not be described in detail because it can be produced by a simple meshing or by a more complex design, without departing from the scope of the invention.

In the example represented, this control system 4 also comprises a control device 6 for each motor 5. The control device 6 associated with one of the motors is similar to the control device 6 associated with the other of the motors 5, so only one control device 6 will be described in detail hereinbelow.

Each control device 6 comprises a lever 7 controlling the direction of rotation and the speed of rotation of the motor associated with the control device 6 and a first sensor 8.

This lever 7 is a pivoting lever which has an active state and an inactive state. This lever 7 is, in the active state, mounted from a neutral position that is movable by pivoting about a first pivot axis in a first, so-called forward direction for a forward drive control at a variable speed of the associated motor, and in a second, so-called reverse direction opposite the first direction for a reverse drive control at a variable speed of the associated motor.

This lever is, in the active state and in neutral position PN further mounted to be movable by pivoting about a second pivot axis YY′ within a range of displacement P1 in a way that is guided in displacement over a part of this range of displacement P1 for the switching of said lever 7 from the active state to an inactive state in which any pivoting displacement of the lever about the first pivot axis XX′ is prevented.

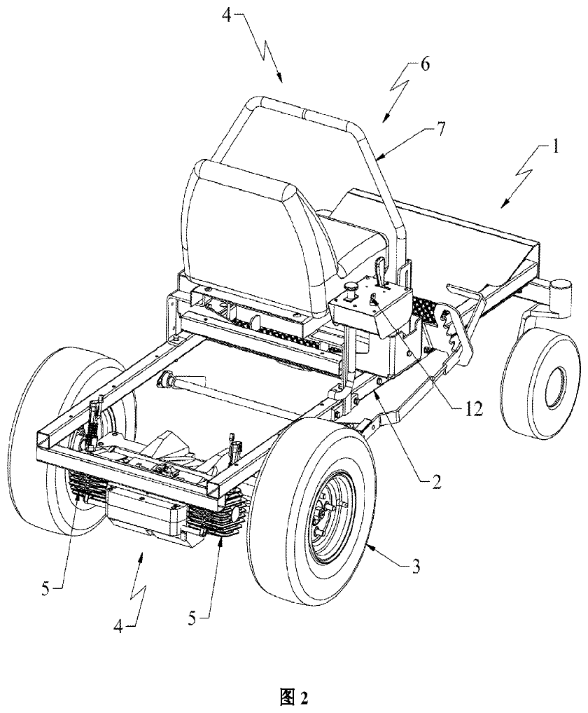

In practice, and as illustrated in FIGS. 1, 2 and 5, the two levers 7 are bent levers which each form a half-arc.

In the neutral position PN of each lever which corresponds to the position in which the speed of rotation of the motor associated with the lever 7 is zero, the levers are arranged aligned and form an arc, as illustrated in FIG. 1.

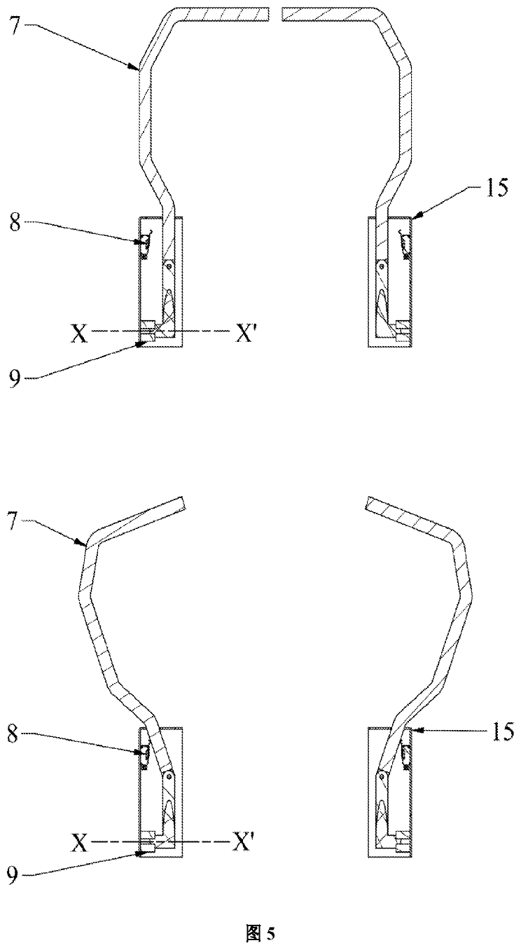

The chassis is equipped with a seat for the driver of the vehicle and the arc is arranged in front of the seat of the driver of the vehicle, such that the driver of the vehicle must, to access the seat of the vehicle, separate the levers 7, thus more widely opening the formed arc at its middle, to allow access to the seat. This separation of the levers is represented in FIG. 5.

This separation of the lever 7 corresponds to the displacement of each of the levers about its second pivot axis YY′, for the switching of the lever from the active state in which said lever is in the neutral position, to the inactive state.

The chassis 2 comprises a front end 18 and a rear end 19 and a longitudinal axis ZZ′ extending from the front end 18 to the rear end 19.

The first pivot axis XX′ of the lever 7 of each control device 6 extends transversely to the longitudinal axis ZZ′ of the chassis 2 and the second pivot axis YY′ of the lever 7 of each control device 6 extends parallel to the longitudinal axis ZZ′ of the chassis 2.

The longitudinal axis of the chassis corresponds to the front/rear direction of the vehicle. Thus, when a lever 7 is mounted to be movable by pivoting about its first pivot axis XX′, it is displaced in the front/rear direction, that is to say towards the front end or towards the rear end of the chassis.

Likewise, when the lever 7 is mounted to be movable by pivoting about the second pivot axis YY′, the lever 7 is displaced to the right or to the left of the vehicle, in the state driven by pivoting of the lever about this second pivot axis YY′.

It will also be noted that, for each control device 6, the first and second pivot axes of the lever of the control device 6 are substantially mutually orthogonal, that is to say orthogonal to one another to within plus or minus 20°. Thus, for each control device 6, the first pivot axis XX′ of the lever 7 is orthogonal to the second pivot axis YY′ of the lever 7.

Likewise, the first and second pivot axes of the lever 7 of one of the control devices 6 are respectively substantially parallel, that is to say parallel to within plus or minus 20°, to the first and second pivot axes of the lever 7 of the other of the control devices 6. Thus, the first pivot axis XX′ of the lever 7 of one of the control devices 6 is parallel to the first pivot axis XX′ of the lever 7 of the other of the control devices 6, whereas the second pivot axis YY′ of the lever 7 of one of the control devices is parallel to the second pivot axis YY′ of the lever 7 of the other of the control devices 6.

To guarantee such a displacement of the levers, each control device 6 comprises a partial protection casing 15 of the associated lever 7, in which two guiding paths 16 and 17 for the lever 7 are formed.

These guiding paths 16 and 17 form between them a T with one of the branches, called first branch of the T, forming the guiding 16 of the lever 7 corresponding to the range P1 of displacement of the lever 7 in which the lever 7 is guided in displacement in the driven state of the lever 7 about the second pivot axis YY′ and the other branch of the T forms the guiding path 17 of the lever 7 in the driven state of the lever 7 about the first pivot axis XX′. These guiding paths 16 and 17 are configured such that any displacement by pivoting of the lever 7 about the first pivot axis XX′ is prevented, in the state of the lever 7 positioned in the guiding path 16 formed by the first branch of the T. The lever 7 is, in the inactive state, arranged in this first guiding path 16.

The neutral position PN of the lever is arranged on the trajectory followed by the lever 7 in the state driven by pivoting displacement of the lever 7 about the second pivot axis YY′ for the switch from the inactive state to the active state. This neutral position corresponds to the end-of-travel position of the lever 7 in the state of the lever 7 driven by pivoting displacement about the second pivot axis YY′ for the switch from the inactive state to the active state. This neutral position corresponds, in the guiding paths, to the intersection of the first and second branches of the T in the second branch of the T.

The vehicle 1 is also equipped with a starter 12.

Conventionally, when the vehicle is started up, the levers 7 are in separated position, that is to say pivoted about a second pivot axis YY′ to occupy an inactive state.

The first sensor 8 is a sensor for detecting at least one position or range of positions of the lever 7 within the range P1 of displacement of the lever 7.

The range P1 of displacement corresponds to the path followed by the lever 7 for the switch from the active state to the inactive state and vice versa. The position or range of positions of the lever 7 detected by the first sensor 8 forms a position zone ZP that can also be called zone of positioning of the lever within the range P1 of displacement of the lever 7.

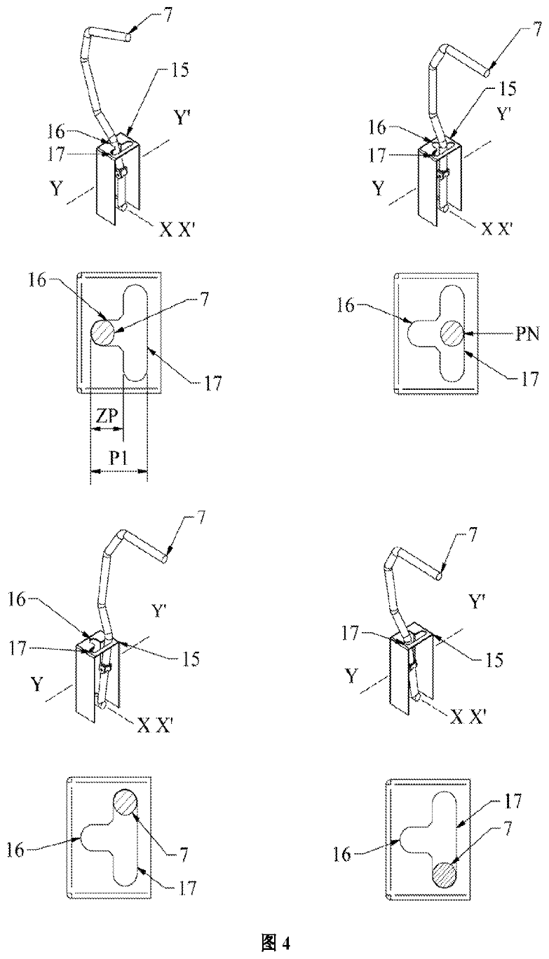

This position zone ZP corresponds to a zone in which any displacement of the lever 7 by pivoting about the first pivot axis XX′ is prevented. This position zone ZP corresponds to all or part of the range of displacement P1 within which the lever 7 is guided in displacement, that is to say to all or part of the first branch of the T forming the guiding path 16. In the examples represented, this first sensor 8 is a proximity sensor with which the lever 7 is, in the inactive state, in bearing contact at the end-of-travel position within the range P1 of displacement. Thus, in the examples represented in FIG. 4, this first sensor 8 is arranged on the casing, directly in line with and below the end of the first branch of the T, embodying the end-of-travel of the lever 7 in the inactive state.

For some vehicle families, this first sensor 8 is installed on said vehicle 1 for other purposes. This first sensor 8 in particular makes it possible to allow the vehicle to be started only in a position of the lever 7 in which, once the vehicle 1 is started, an immediate advance of the vehicle 1 resulting from the position of the lever 7 is impossible.

The invention retains this first function of the first sensor 8, but confers on this first sensor 8 a second function that makes it possible, using this first sensor 8, to assist the identifying and the storing of the neutral position PN of the lever 7. In fact, each control device 6 comprises a second sensor 9 for detecting the angular position of the associated lever 7 about said first pivot axis XX′, a memory 10 for storing the neutral position PN of said lever 7 and a control unit 11 configured to acquire the data from said second sensor 9 and to, in the active state of the lever 7, control the speed and the direction of rotation of the associated motor 5, as a function of the data from the second sensor 9 and of the stored neutral position PN.

The control unit takes the form of an electronic and computing system which comprises, for example, a microprocessor and a working memory. According to a particular aspect, the control unit can take the form of a programmable logic controller.

In other words, the functions and steps described can be implemented in computer program form or via hardware components (for example, programmable gate arrays). In particular, the functions and steps applied by the control unit or its modules can be performed by instruction sets or computer modules implemented in a processor or controller or be carried out by dedicated electronic components or components of FPGA or ASIC type. It is also possible to combine computing parts and electronic parts.

When it is specified that the unit or means or modules of said unit are configured to perform a given operation, that means that the unit comprises computing instructions and corresponding execution means which make it possible to perform said operation and/or the unit comprises corresponding electronic components.

In the examples represented, the second sensor 9 is a potentiometer arranged at the first pivot axis XX′. This second sensor 9 makes it possible to continually measure the angular position of the lever 7 with respect to the neutral position PN about the first pivot axis XX′.

The lever 7 is thus, in the active state, mounted from the neutral position PN to be movable by pivoting about the first pivot axis XX′ in a first, so-called forward direction, to a forward end-of-travel position for a forward drive control at a variable speed of the associated motor 5, as a function of the angular position of the lever 7 with respect to the neutral position PN and in a second, so-called reverse direction opposite the first direction to a reverse end-of-travel position for a reverse drive control at a variable speed of the associated motor 5, as a function of the angular position of the lever with respect to the neutral position PN.

The vehicle can also comprise at least one memory 13 for storing the forward end-of-travel position 7 and a memory 14 for storing the reverse end-of-travel position of the lever 7.

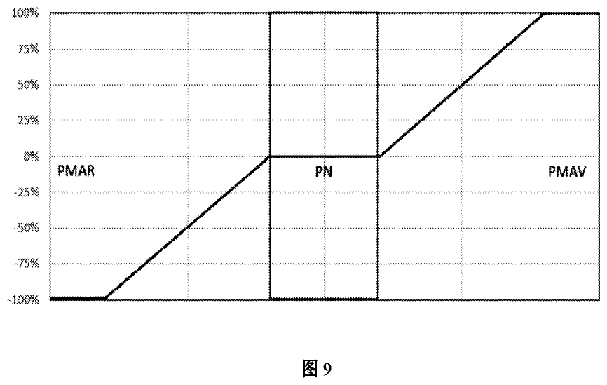

The control unit 11 is configured to, as a function of the neutral position and of the stored forward and reverse end-of-travel positions, establish a curve of the speed of rotation of the motor as a function of the angular position of the lever 7 as illustrated in FIG. 9 in which the x axis corresponds to the angular position of the lever and the y axis corresponds by convention to the speed of rotation of the motor with 0% corresponding to the neutral position that is to say to the zero speed of the motor, and 100% and −100% respectively correspond to the maximum forward and reverse speeds of the motor. Thus, each time, when the lever 7 is in the active state and is displaced towards the front end of the chassis from the neutral position, the second sensor returns an electrical voltage corresponding to the angle of the lever 7 with respect to the neutral position.

Likewise, when the lever 7 is driven in displacement by the driver of the vehicle towards the rear end of the chassis from the neutral position, the second sensor returns an electrical voltage corresponding to the angle of the lever with respect to the neutral position PN and the control unit controls the operation of the electric motors and, in particular, their speed of rotation as a function of the information received from the second sensor.

In the neutral position PN of the lever 7, the value of the angular position of the lever 7 with respect to the first pivot axis XX′ measured by the second sensor 9 does not vary during the switching of the lever 7 from the active state in which it is in neutral position to the inactive state.

Consequently, the vehicle 1 comprises at least one so-called calibration mode of operation in which the control unit 11 is configured to order a storage of the neutral position PN corresponding to a datum supplied by the second sensor 9, at least as a function of the data supplied by the first sensor 8.

In practice, the control unit 11 is configured to, in the so-called calibration mode of operation, order a storage of the neutral position PN corresponding to a datum supplied by the second sensor 9 when the lever 7 is in the position zone ZP detected by the first sensor 8 or when the lever 7 is displaced in the direction of an entry into or of an exit from the position zone ZP detected by the first sensor 8.

The storage of the neutral position PN corresponding to a datum supplied by the second sensor 9 when the first sensor 8 detects that the lever 7 is in the position zone PN detected by the first sensor 8 or that the lever 7 is entering into or exiting from the position zone PN detected by the first sensor 8, which is reflected by a change of state of the first sensor 8 can be systematic or not. In fact, the control unit 11 can systematically order the storage of the neutral position PN as a function of the data supplied by the first sensor 8 or order this storage only if the datum supplied by the second sensor 9 corresponds to an angular position value of the lever 7 that is different from the value of the neutral position previously stored, that is to say stored in memory in the neutral position memory 10.

In the examples represented, the calibration mode of operation is an activatable/deactivatable mode. The deactivation of the calibration mode of operation is controlled by the control unit 11. The same can apply to activation. The activation can also be a default activation at the moment when the vehicle 1 is started up.

Whatever the conditions of activation of the calibration mode of operation, the control unit 11 is configured to, following a start-up of the vehicle 1 and in the activated state of the calibration mode of operation
detect, as a function of the data supplied by the first sensor 8, the position of the lever 7 with respect to the position zone ZP,
store, when the lever 7 is in the position zone ZP or is displaced in the direction of an entry into or of an exit from the position zone ZP, the neutral position PN corresponding to a datum supplied by the second sensor 9, at least if the datum supplied by the second sensor 9 corresponds to a value of the angular position of the lever 7 that is different from the stored neutral position,
deactivate said calibration mode of operation.

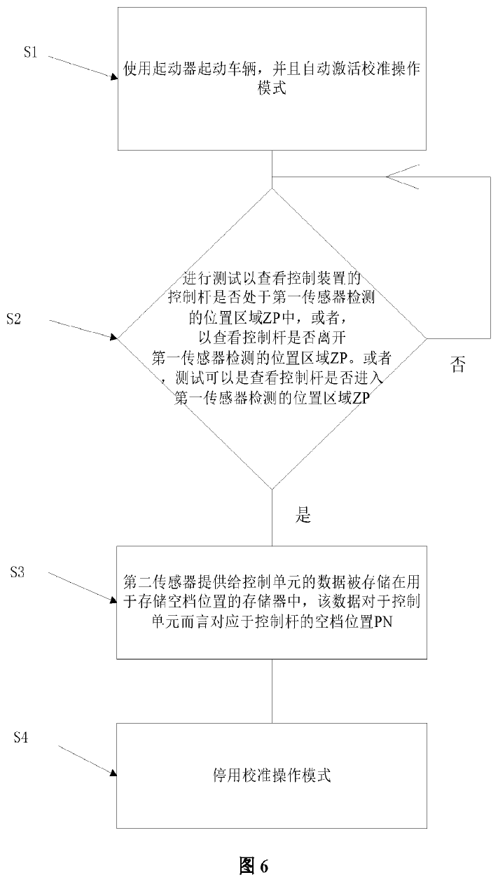

FIGS. 6 to 8 illustrate different scenarios.

FIG. 6 illustrates the simplest scenario. In the step S1, the vehicle 1 is started using the starter 12 and the calibration mode of operation is automatically activated. When the vehicle 1 is started up, each lever 7 is necessarily in the inactive state and in the position zone ZP detected by the first sensor 8, failing which the vehicle would not have started.

FIG. 6 illustrates a scenario for a control device. This scenario is the same for the other control device. The two scenarios proceed independently of one another. Each control device can follow such a scenario.

In the step S2, a test is run to see if the lever of the control device is in the position zone ZP detected by the first sensor 8 or, as a variant, to see if the lever 7 exits from the position zone ZP detected by the first sensor 8. In another variant, the test could have been to see if the lever enters into the position zone ZP detected by the first sensor 8.

If the response is yes, in the step S3, the datum supplied to the control unit by the second sensor 9 which corresponds, for the control unit 11, to the neutral position PN of the lever 7, is stored in the memory 10 for storing the neutral position. In the step S4, the calibration mode of operation is deactivated.

If the response to the test of the step S2 is no, the test of the step S2 is repeated.

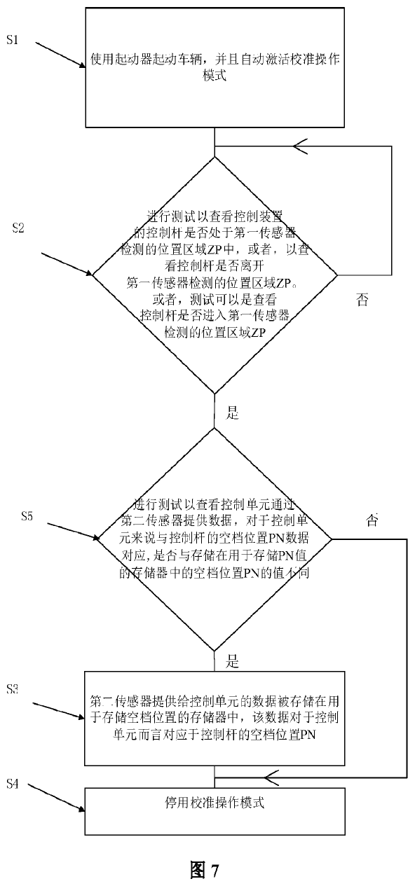

The scenario of FIG. 7 reproduces the steps S1 to S4 of FIG. 6 and is distinguished from this scenario of FIG. 6 by the fact that, between the step S2 and the step S3, a step S5 is executed during which a test is run to see if the datum supplied by the control unit 11 by the second sensor 9, and which corresponds, for the control unit 11, to the neutral position PN of the lever 7, is different from the value of the neutral position PN stored in the memory 10 for storing the PN value.

If the response is yes, then the method proceeds to the step S3. Otherwise, the method proceeds directly to the step S4.

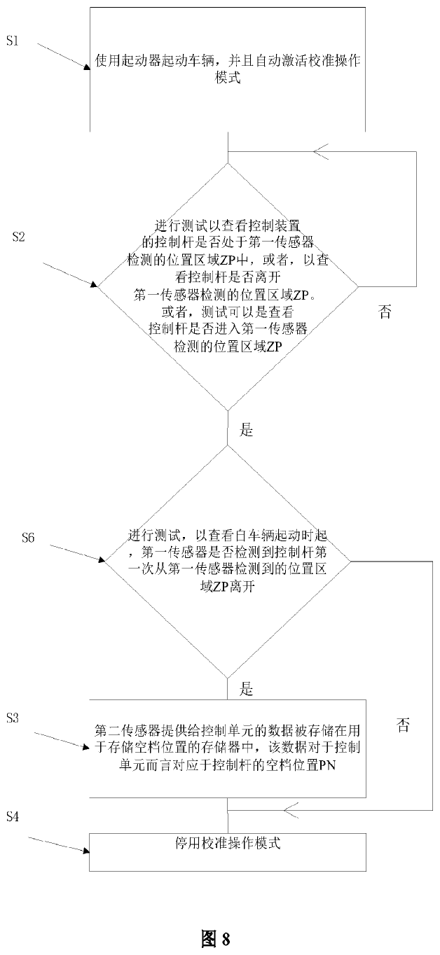

FIG. 8 illustrates another scenario, which reprises the steps S1 to S4 of the scenario of FIG. 6 and in which a step S6 is added that is inserted between the steps S2 and S3. In this step S6, a test is run to see if the first sensor 8 detects, for the first time, the exiting of the lever 7 from the position zone ZP detected by the first sensor 8 since the starting of the vehicle 1.

This test can in practice be carried out by comparing data supplied by a counter which counts the number of times when the first sensor changes state with the data supplied by a second counter which counts the number of starts of the vehicle. Based on the result of this comparison, the control unit 11 can be determined if the lever exits from the position zone ZP detected by the sensor 8 for the first time or not since the starting of the vehicle.

If the response to this question is yes, the control unit goes onto the step S7. Otherwise, the control unit 11 goes onto the step S4.

Obviously, other scenarios, which can notably comprise a combination of the scenarios described above, can be envisaged without departing from the scope of the invention.

Independently of the stored PN position value, the operation of such a vehicle in the active state of the levers 7 is identical to that of the state of the art.

In particular, when the two levers 7 which are in the active state are pushed forwards simultaneously and with the same force from their respective neutral position, the vehicle moves forwards. When the two levers 7 are pushed backwards simultaneously and with the same force from their respective neutral position, the vehicle moves in reverse. When one lever is pushed more than the other, the vehicle performs a turn. Pushing one of the levers forwards and the other backwards makes it possible to have the vehicle turn on itself.

The switching of a lever from the active state to the inactive state prevents any rotational driving of the associated wheel.

The possibility at any time, chosen by the manufacturer of the vehicle, and in particular each time the vehicle is started up, of updating the stored neutral position allows the vehicle to be driven more comfortably. This function allows for an automatic recalibration of the neutral position during the operating life of the vehicle, and makes it possible to eliminate pairing when the vehicle is manufactured, so as to have optimal operation of said vehicle.

This possibility also makes it possible to avoid the need for a return to the factory when the second sensor has to be changed.

1. A rolling vehicle comprising:
a chassis equipped with at least one pair of drive wheels and a system controlling the rotational driving of the drive wheels of the or of at least one of the pairs of drive wheels, said control system having at least two motors and a control device for each motor, said motors being capable of allowing, for one, the rotational driving of one of the drive wheels, and for the other, the rotational driving of the other of the drive wheels of the pair of drive wheels, each control device having a lever controlling the direction of rotation and the speed of rotation of the motor associated with said control device and a first sensor, said lever being a pivoting lever with an active state and an inactive state, said lever being, in the so-called active state, mounted, from a so-called neutral position, to be mobile by pivoting about a first pivot axis in a first, so-called forward direction, for a forward drive control at a variable speed of the associated motor, and in a second, so-called reverse direction, opposite the first direction, for a reverse drive control at a variable speed of the associated motor, this lever being, in the active state and in neutral position, further mounted to be mobile by pivoting about a second pivot axis within a range of displacement, in a way that is guided in displacement over a part of this range of displacement, for the switching of said lever from an active state to an inactive state in which any pivoting displacement of the lever about the first pivot axis is prevented, the first sensor being a sensor for detecting at least one position or range of positions of the associated lever within this range of displacement, this position or range of positions forming a position zone of the lever in which any pivoting displacement about the first pivot axis of the lever, which is guided in displacement, is prevented,
wherein each control device comprises has a second sensor for detecting the angular position of said associated lever about said first pivot axis, a memory for storing the neutral position of said lever and a control unit configured to acquire the data from said second sensor and to, in the active state of the lever, control the speed and the direction of rotation of the associated motor as a function of the data from the second sensor and of the stored neutral position, and in that the vehicle has at least one operating mode, called calibration, in which the control unit is configured to order a storage of the neutral position corresponding to a datum supplied by the second sensor at least as a function of the data supplied by the first sensor.

2. The rolling vehicle according to claim 1, wherein the control unit is configured to, in the so-called calibration operating mode, order a storage of the neutral position corresponding to a datum supplied by the second sensor when the lever is in the position zone detected by the first sensor.

3. The rolling vehicle according to claim 1, wherein the control unit is configured to, in the so-called calibration operating mode, order a storage of the neutral position corresponding to a datum supplied by the second sensor when the lever is displaced in the direction of an exit from and/or entry into the position zone detected by the first sensor.

4. The rolling vehicle according to claim 1, wherein the control unit which is configured to, in the so-called calibration operating mode, order a storage of the neutral position corresponding to a datum supplied by the second sensor at least as a function of the data supplied by the first sensor, is configured to order said storage if the datum supplied by the second sensor corresponds to an angular position value of the lever that is different from the value of the neutral position previously stored.

5. The rolling vehicle according to claim 1, wherein the so-called calibration operating mode is an activatable/deactivatable mode.

6. The rolling vehicle according to claim 5, wherein the control unit is configured to, following a start-up of the vehicle and when the calibration operating mode is in the activated state:
detect, as a function of the data supplied by the first sensor (8), the position of the lever with respect to the position zone,
store, when the lever is in the position zone or is displaced in the direction of an exit from and/or of an entry into the position zone, the neutral position corresponding to a datum supplied by the second sensor at least if the datum supplied by the second sensor corresponds to a value of the angular position of the lever that is different from the stored neutral position,
deactivate said calibration operating mode.

7. The rolling vehicle according to claim 1, wherein, the lever being, in the active state, mounted from a neutral position to be movable by pivoting about the first pivot axis in a first direction, called forward, to a forward end-of-travel position for a forward driving control at a variable speed of the associated motor as a function of the angular position of the lever with respect to the neutral position and in a second direction, called reverse, opposite the first direction, to a reverse end-of-travel position for a reverse driving control at a variable speed of the associated motor as a function of the angular position of the lever with respect to the neutral position, the vehicle has at least one memory for storing the forward end-of-travel position of the lever and a memory for storing the reverse end-of-travel position of the lever and in that the control unit is configured to, as a function of the neutral position and of the stored forward and reverse end-of-travel positions, establish a curve of the speed of rotation of the motor as a function of the angular position of the lever.

8. The rolling vehicle according to claim 1, wherein the neutral position, which is arranged on the trajectory followed by the lever, in the state driven in displacement by pivoting of said lever about the second pivot axis for the switch from the active state to the inactive state, corresponds to the end-of-travel position of the lever in the state of the lever driven in displacement by pivoting about the second pivot axis for the switch from the inactive state to the active state.

9. The rolling vehicle according to claim 1, wherein each control device further comprises a partial protection casing of the associated lever in which there are formed two paths for guiding the lever, these guiding paths forming a T between them with one of the branches, called first branch of the T, forming the path for guiding the lever corresponding to the part of the range of displacement of the lever at which the lever is guided in displacement in the state of the lever driven about the second pivot axis and the other branch of the T forming the path for guiding the lever in the state of the lever driven about the first pivot axis, said guiding paths (16, 17) being configured such that any displacement by pivoting of the lever about the first pivot axis is prevented in the state of the lever positioned in the guiding path formed by the first branch of the T, said lever being in the inactive state arranged in this first guiding path.

10. The rolling vehicle according to claim 1, wherein the chassis further comprises a front end and a rear end and a longitudinal axis extending from the front end towards the rear end, in that the first pivot axis of the lever of each control device extends transversely to the longitudinal axis of the chassis and the second pivot axis of the lever of each control device extends parallel to the longitudinal axis of the chassis.

11. The rolling vehicle according to claim 1, wherein, for each control device, the first and second pivot axes of the lever of the control device are substantially orthogonal to one another.

12. The rolling vehicle according to claim 1, wherein the first and second pivot axes of the lever of one of the control devices are respectively substantially parallel to the first and second pivot axes of the lever of the other of the control devices.

13. The rolling vehicle according to claim 1, wherein, for at least one of the control devices, the first sensor is a proximity sensor with which the lever is, in the inactive state, in bearing contact in the end-of-travel position within the range of displacement and in that the second sensor is a potentiometer.
